(19) United States
(12) Patent Application Publication
(10) Pub. No.: US 2013/0059945 A1
(43) Pub. Date: Mar. 7, 2013

(54) CURABLE COMPOSITIONS

(71) Applicants: Maurice J. Marks, Lake Jackson, TX (US); Roy V. Snelgrove, Damon, TX (US)

(72) Inventors: Maurice J. Marks, Lake Jackson, TX (US); Roy V. Snelgrove, Damon, TX (US)

(21) Appl. No.: 13/696,814

(22) PCT Filed: May 18, 2011
(86) PCT No.: PCT/US11/36945

§ 371 Date: Nov. 8, 2012

Related U.S. Application Data
(60) Provisional application No. 61/347,074, filed on May 21, 2010.

(51) Int. Cl. C08K 5/1515; C09D 163/08; C09J 163/08; C08L 63/08

(52) U.S. Cl. 523/456

(57) ABSTRACT

A curable divinylarene dioxide resin composition having a stoichiometric excess of divinylarene dioxides cured with amines, anhydrides, or polyphenols. The curable divinylarene dioxide resin composition includes (a) a stoichiometric excess of at least one divinylarene dioxide, (b) a co-reactive curing agent, and a catalyst. A process for making the above curable divinylarene dioxide resin composition; and a cured divinylarene dioxide resin composition made therefrom are also disclosed. The curable divinylarene dioxide resin composition has a longer pot life prior to cure and produces a thermoset having a higher heat resistance after cure than analogous prior art compositions made using stoichiometric compositions. The curable compositions of the present invention are advantageously useful as thermoset materials, coatings, composites, and adhesives.

### BACKGROUND OF THE INVENTION

1. Field of the Invention

The present invention is related to curable formulations or compositions including a stoichiometric excess of a divinylarene dioxide, a co-reactive curing agent, and a catalyst.

2. Description of Background and Related Art

Divinylarene dioxides such as divinylbenzene dioxide (DVBDO) are known to be used in the epoxy resin matrix component in curable compositions for producing thermoset resin products. Previously, divinylarene dioxides have been used in stoichiometric amounts with amine, anhydride, or phenolic curing agents. For example, GB 854679 describes curable compositions of stoichiometric amounts of divinylbenzene dioxide and polyfunctional amines; GB 855025 describes curable compositions of stoichiometric amounts of divinylbenzene dioxide and carboxylic acid anhydrides; and JP 2009119513 describes curable compositions of stoichiometric amounts of divinylbenzene dioxide and polyphenols. The above prior art does not teach the advantages of using a stoichiometric excess of a divinylarene dioxide as the epoxide component in a curable composition.

WO 2008140906 A1 describes curable compositions having an excess of epoxy resins and curing agents, but WO 2008140906 does not disclose the use of divinylarene dioxides as the epoxide resin component in a curable composition. WO 2008140906 A1 also does not describe the advantages of using a stoichiometric excess of a divinylarene dioxide as the epoxide component in a curable composition.

For example, the prior known divinylarene dioxide-containing curable compositions have a lower than desired pot life and the resulting thermosets have a lower than desired heat resistance for many applications. Curable divinylarene dioxide compositions having an improved pot life prior to cure and an improved heat resistance after cure are needed in many epoxy thermoset applications.

None of the references cited above disclose longer pot life or higher heat resistance properties resulting from curable compositions of a stoichiometric excess of a divinylarene dioxides and a curing agent.

### SUMMARY OF THE INVENTION

The present invention is directed to curable (also referred to as polymerizable or thermosettable) formulations or compositions having a stoichiometric excess of divinylarene dioxides and co-reactive curing agents such as amines, anhydrides, or polyphenols that have a longer pot life prior to cure and produce a thermoset or cured product having a higher heat resistance after cure compared to analogous prior art compositions made using stoichiometric compositions. The curable compositions of the present invention are advantageously useful as thermoset materials, coatings, composites, and adhesives.

One broad embodiment of the present invention comprises a curable epoxy resin composition including (a) a stoichiometric excess of a divinylarene dioxide, (b) a co-reactive curing agent, and (c) a catalyst, wherein the composition exhibits a long pot life prior to curing the composition.

Another broad embodiment of the present invention comprises a curable epoxy resin composition including (a) a stoichiometric excess of a divinylarene dioxide, (b) a co-reactive curing agent, and (c) a catalyst to effect reaction of the excess epoxide; wherein upon curing the curable composition, the resultant cured composition provides a durable thermoset material.

### DETAILED DESCRIPTION OF THE INVENTION

The divinylarene dioxide, component (a), useful in the present invention may comprise, for example, any substituted or unsubstituted arene nucleus bearing one, two, or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthlalene, tetrahydronaphthalene, and the like. Homologously bonded (substituted) benzenes may consist of biphenyl, diphenylether, and the like.

The divinylarene dioxide used for preparing the composition of the present invention may be illustrated generally by general chemical Structures I-IV as follows:

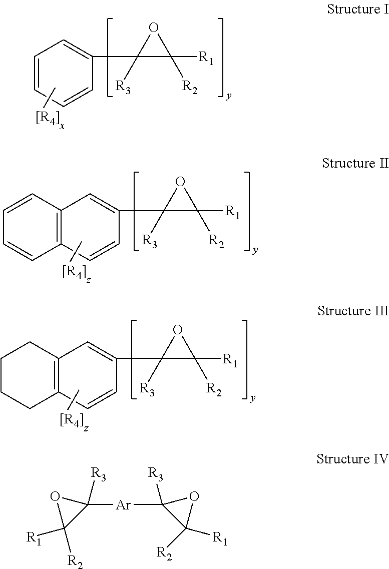

In the above Structures 1, II, III, and IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In one embodiment, the divinylarene dioxide used in the present invention may be produced, for example, by the process described in U.S. Patent Provisional Application Ser. No. 61/141,457, filed Dec. 30, 2008, by Marks et al., incorporated herein by reference. The divinylarene dioxide compositions that are useful in the present invention are also disclosed in, for example, U.S. Pat. No. 2,924,580, incorporated herein by reference.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In a preferred embodiment of the present invention, the divinylarene dioxide used in the epoxy resin composition may be for example divinylbenzene dioxide (DVBDO). Most preferably, the divinylarene dioxide component that is useful in the present invention includes, for example, a divinylbenzene dioxide as illustrated by the following chemical formula of Structure V:

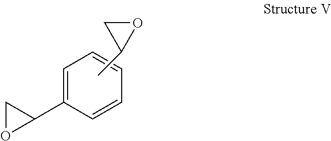

The chemical formula of the above DVBDO compound of Structure V may be as follows: C₁₀H₁₀O₂; the molecular weight of the DVBDO may be about 162.2; and the elemental analysis of the DVBDO may be about as follows: C, 74.06; H, 6.21; and O, 19.73 with an epoxide equivalent weight of about 81 g/mol.

Divinylarene dioxides, particularly those derived from divinylbenzene such as for example DVBDO, are class of diepoxides which have a relatively low liquid viscosity but a higher rigidity and crosslink density than conventional epoxy resins.

Structure VI below illustrates an embodiment of a preferred chemical structure of the DVBDO useful in the present invention:

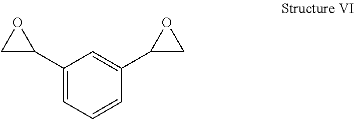 [SMILES: c1cc(C2CO2)cc(C2CO2)c1]

Structure VII below illustrates another embodiment of a preferred chemical structure of the DVBDO useful in the present invention:

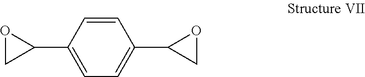 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) and para isomers of DVBDO, respectively. The ortho isomer is rare; and usually DVBDO is mostly produced generally in a range of from about 9:1 to about 1:9 ratio of meta (Structure VI) to para (Structure VII) isomers. The present invention preferably includes as one embodiment a range of from about 6:1 to about 1:6 ratio of Structure VI to Structure VII, and in other embodiments the ratio of Structure VI to Structure VII may be from about 4:1 to about 1:4 or from about 2:1 to about 1:2.

In yet another embodiment of the present invention, the divinylarene dioxide may contain quantities (such as for example less than about 20 weight percent [wt %]) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound but can be utilized at levels of 0 to 99% of the epoxy resin portion.

In one embodiment, the divinylarene dioxide useful in the present invention comprises, for example, DVBDO, a low viscosity liquid epoxy resin. The viscosity of the divinylarene dioxide used in the process of the present invention ranges generally from about 0.001 Pa s to about 0.1 Pa s, preferably from about 0.01 Pa s to about 0.05 Pa s, and more preferably from about 0.01 Pa s to about 0.025 Pa s, at 25° C.

The utility of the divinylarene dioxides of the present invention requires thermal stability to allow formulating or processing the divinylarene dioxides at moderate temperatures (for example, at temperatures of from about 100° C. to about 200° C.) for up to several hours (for example, for at least 2 hours) without oligomerization or homopolymerization. Oligomerization or homopolymerization during formulation or processing is evident by a substantial increase (e.g., greater than 50 fold) in viscosity or gelling (crosslinking). The divinylarene dioxides of the present invention have sufficient thermal stability such that the divinylarene dioxides do not experience a substantial increase in viscosity or gelling during formulation or processing at the aforementioned moderate temperatures.

Another advantageous property of the divinylarene dioxide useful in the present invention is its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from about 6 to about 10, preferably from about 6 to about 9, and more preferably from about 6 to about 8 rotational degrees of freedom.

The concentration of the divinylbenzene dioxide in the composition of the present invention will include a stoichiometric excess. The stoichiometric excess of divinylarene dioxides used is determined using the number of epoxide equivalents or the number of moles depending on the class of co-reactive curing agent used, as described below.

In general, the concentration of the divinylarene oxide used in the present invention as component (a) of the composition may range in terms of equivalent ratio of epoxide to co-reactive curing agent generally from about 1.05 to about 10 in one embodiment, from about 1.05 to about 7 in another embodiment, from about 1.05 to about 5 in still another embodiment, and from about 1.05 to about 3 in yet another embodiment.

In one preferred embodiment of the composition of the present invention, divinylbenzene dioxide as component (a) may be used in terms of equivalent ratio of epoxide to co-reactive curing agent from about 1.1 to about 2.

The use of divinylarene dioxide in amounts greater than that listed above result in compositions having insignificant concentrations of co-reactive curing agent and thereby have properties which are essentially the same as divinylarene dioxide alone. The use of divinylarene dioxide in amounts less that than listed above result in compositions having concentrations of co-reactive curing agent which are essentially the same as at stoichiometric balance or have an excess of curing agent. Curable compositions using a stoichiometric excess of co-reactive curing agent have lower degrees of cure resulting in a reduced heat resistance.

The co-reactive curing agent, component (b), useful for the curable epoxy resin composition of the present invention, may comprise any conventional co-reactive curing agent known in the art for curing epoxy resins. The curing agents, (also referred to as a hardener or cross-linking agent) useful in the curable composition, may be selected, for example, from those curing agents well known in the art including, but are not limited to, anhydrides, carboxylic acids, amine compounds, phenolic compounds, thiols, or mixtures thereof.

Examples of co-reactive curing agents useful in the present invention may include any of the co-reactive curing materials known to be useful for curing epoxy resin based compositions. Such co-reactive curing agents include, for example, polyamine, polyamide, polyaminoamide, dicyandiamide, polyphenol, polymeric thiol, polycarboxylic acid and anhydride, and any combination thereof or the like. Other specific examples of co-reactive curing agent include phenol novolacs, bisphenol-A novolacs, phenol novolac of dicyclopentadiene, cresol novolac, diaminodiphenylsulfone, styrene-maleic acid anhydride (SMA) copolymers; and any combination thereof. Among the conventional co-reactive epoxy curing agents, amines and amino or amido containing resins and phenolics are preferred.

Preferably, the curable resin compositions of the present invention can be cured using various standard co-reactive curing agents including for example amines, carboxylic acid anhydride, polyphenols, and mixtures thereof.

The amine curing agent may comprise any substituted or unsubstituted polyamine such as an ethylene amine exemplified by ethylenediamine, diethylenetriamine, triethylenetetramine, and aminoethylpiperazine; a cycloaliphatic amine such a isophoronediamine; a benzylic amine such as xylylene diamine; an aromatic amine such as methylenedianiline and diethyltoluenediamine; and mixtures thereof. Stoichiometric excess of divinylarene dioxides is determined using the number of epoxide equivalents relative to the number of amine hydrogen equivalents of the amine curing agent.

The carboxylic acid anhydride curing agent may comprise any substituted or unsubstituted anhydride such as phthalic anhydride, tetrahydrophthalic anhydride, methyltetrahydrophthalic anhydride, nadic anhydride and mixtures thereof. Stoichiometric excess of divinylarene dioxides is determined using the number of moles of divinylarene dioxide relative to the number of moles of anhydride curing agent.

The polyphenol curing agent may comprise any substituted or unsubstituted polyphenol such as a phenol novolac resin, a cresol novolac resin, and a bisphenol A novolac resin, a multi-phenolic compound such as cyclohexanetetraphenol, and a phenolic hardener such as D.E.H. 80 phenolic resin, and optionally including a diphenol such as bisphenol A, and also optionally including a monophenol such as p-t-butylphenol. Stoichiometric excess of divinylarene dioxides is determined using the number of epoxide equivalents relative to the number of phenolic equivalents of the polyphenol curing agent.

Dicyandiamide may be one preferred embodiment of the curing agent useful in the present invention. Dicyandiamide has the advantage of providing delayed curing since dicyandiamide requires relatively high temperatures for activating its curing properties; and thus, dicyandiamide can be added to an epoxy resin and stored at room temperature (about 25° C.).

The thiol curing agent may comprise any substituted or unsubstituted polysulfide or polymercaptan compound. Specific examples of the compounds useful as the curing agent include the Thiokol LP series of polyalkylether thiols produced by Toray Fine Chemicals Co., Ltd. and Capcure LOF polymercaptan from Cognis Corp.

The catalyst, component (c), useful for the curable epoxy resin composition of the present invention, may comprise any conventional catalyst known in the art for effecting the reaction between a curing agent and an epoxy resin. The catalysts, useful in the curable composition, may be selected, for example, from those catalysts well known in the art including, but are not limited to, tertiary amines, imidazoles, quaternary ammonium salts, quaternary phosphonium salts, Lewis acid-Lewis base complexes, or mixtures thereof.

Preferably, the catalysts useful in the present invention include for example, a tertiary amine such as benzyldimethylamine; an imidazole such as 1-benzyl-2-methylimidazole; a quaternary ammonium salt such as tetrabutylammonium bromide; a phosphonium salt such as tetrabutylphosphonium bromide; Lewis acid-Lewis base complexes such as boron trichloride-ethylamine complex; and mixtures thereof.

In general, the epoxy resin composition of the present invention may include from about 0.01 wt % to about 20 wt % the catalyst. In other embodiments, the composition may include from about 0.05 wt % to about 15 wt % catalyst; from about 0.1 wt % to about 10 wt % catalyst in other embodiments; from about 0.2 wt % to about 7 wt % catalyst in other embodiments; and from about 0.5 wt % to about 5 wt % catalyst in yet other embodiments.

Using a catalyst concentration lower than that described in the above range, results in an insufficient rate and degree of cure of the composition, whereas using a catalyst concentration greater than that described in the above range, results in an undesirably fast rate of cure and/or a deleterious effect on the properties of the cured composition as a result of, for example, plasticization or phase separation.

Also to facilitate the reaction of the divinylarene dioxide compound and the curing agent, an optional solvent may be used in preparing the curable divinylarene dioxide resin composition of the present invention. For example, one or more organic solvents well known in the art may include aromatic hydrocarbons, alkyl halides, ketones, alcohols, ethers, and mixtures thereof.

The concentration of the solvent used in the present invention may range generally from 0 wt % to about 95 wt %, preferably from about 0.01 wt % to about 80 wt %; more preferably from about 0.01 wt % to about 60 wt %; and most preferably from about 0.01 wt % to about 50 wt %.

Other optional components that may be useful in the present invention are components normally used in resin compositions known to those skilled in the art. For example, the optional components may comprise compounds that can be added to the composition to enhance application properties (e.g. surface tension modifiers or flow aids), reliability properties (e.g. adhesion promoters) the reaction rate, the selectivity of the reaction, and/or the catalyst lifetime.

An assortment of optional additives that may be added to the curable compositions of the present invention include for example, other resins such as epoxy resins that are different from the divinylarene dioxide, component (a); diluents; stabilizers; fillers; plasticizers; catalyst de-activators; and the like; and mixtures thereof.

Other optional additives useful in the composition of the present invention include for example fillers such as clay, talc, silica, and calcium carbonate; solvents such as ethers and alcohols; toughening agents such as elastomers and liquid block copolymers; pigments such as carbon black and iron oxide; surfactants such as silicones; fibers such as fiberglass and carbon fiber; and mixtures thereof.

The concentration of the optional components useful in the composition of the present invention may range generally from 0 wt % to about 99.9 wt %, preferably from about 0.001 wt % to about 99 wt %, more preferably from about 0.01 wt % to about 98 wt %, and most preferably from about 0.05 wt % to about 95 wt %.

The preparation of the curable divinylarene dioxide resin composition of the present invention is achieved by admixing (a) an excess of a stoichiometric amount of a divinylarene dioxide, (b) a co-reactive curing agent, and (c) a catalyst, and other optional components. The above components may be mixed in any order. Any of the above-mentioned optional assorted composition additives, for example fillers, may also be added to the composition during the mixing or prior to the mixing to form the composition. In a preferred embodiment the divinylarene dioxide, co-reactive curing agent, and optional components are admixed prior to addition of the curing catalyst.

All the components of the curable divinylarene dioxide resin composition are typically mixed and dispersed at a temperature enabling the preparation of an effective curable divinylarene dioxide resin composition having a low viscosity for the desired application. The temperature during the mixing of all components may be generally from about 0° C. to about 100° C. and preferably from about 20° C. to about 70° C. In a preferred embodiment, the excess divinylarene dioxide and co-reactive curing agent are mixed until homogeneously dispersed or dissolved prior to addition of optional components and catalyst.

The curable composition comprises a stoichiometric excess of a divinylarene dioxide, a co-reactive curing agent, and a catalyst, optionally including solvents and optional components as described above. The curable composition of the present invention has a pot life increased over that of its stoichiometric analog of from about 10% to about 10,000%, preferably from about 20% to about 5,000%, and most preferably from about 50% to about 1,000%.

The curable composition of the present invention can be cured under conventional processing conditions to form a thermoset. The resulting thermoset displays excellent thermo-mechanical properties, such as good toughness and mechanical strength, while maintaining high thermal stability.

The process to produce the thermoset products of the present invention may be performed by gravity casting, vacuum casting, automatic pressure gelation (APG), vacuum pressure gelation (VPG), infusion, filament winding, lay up injection, transfer molding, prepreging, dipping, coating, spraying, brushing, and the like.

The curing reaction conditions include, for example, carrying out the curing reaction under a temperature, generally in the range of from about 40° C. to about 300° C.; preferably, from about 50° C. to about 275° C.; and more preferably, from about 60° C. to about 250° C.

The pressure of the curing reaction may be carried out, for example, at a pressure of from about 0.01 bar to about 1000 bar; preferably, from about 0.1 bar to about 100 bar; and more preferably, from about 0.5 bar to about 10 bar.

The curing of the curable composition may be carried out, for example, for a predetermined period of time sufficient to partially cure or to completely cure the composition. For example, the curing time may be chosen between about 1 minute to about 24 hours, preferably between about 10 minutes to about 12 hours, and more preferably between about 100 minutes to about 8 hours.

The curing process of the present invention may be a batch or a continuous process. The reactor used in the process may be any reactor and ancillary equipment well known to those skilled in the art.

The cured or thermoset product prepared by curing the curable divinylarene dioxide resin composition of the present invention advantageously exhibits an improved balance of thermo-mechanical properties (e.g. glass transition temperature, modulus, and toughness.

The curable divinylarene dioxide resin composition of the present invention, when cured, is capable of providing a thermoset or cured product wherein the heat resistance of the thermoset ranges generally from about 25° C. to about 300° C.; preferably, from about 50° C. to about 275° C.; and more preferably, from about 100° C. to about 250° C. as measured by the glass transition temperature (T_{g}) using differential scanning calorimetry (DSC).

The curable compositions of the present invention have a T_{g} increased over that of its stoichiometric analog from about 5% to about 100%, preferably of about 5% to about 75%, and most preferably from about 10% to about 50%.

The curable divinylarene dioxide resin compositions of the present invention are useful for the preparation of epoxy thermosets or cured products in the form of coatings, films, adhesives, laminates, composites, electronics, and the like.

As an illustration of the present invention, in general, the curable divinylarene dioxide resin compositions may be useful for casting, potting, encapsulation, molding, and tooling. The present invention is particularly suitable for all types of electrical casting, potting, and encapsulation applications; for molding and plastic tooling; and for the fabrication of divinylarene dioxide resin based composites parts, particularly for producing large epoxy resin-based parts produced by casting, potting and encapsulation. The resulting composite material may be useful in some applications, such as electrical casting applications or electronic encapsulations, castings, moldings, potting, encapsulations, injection, resin transfer moldings, composites, coatings and the like.

### EXAMPLES

The following examples and comparative examples further illustrate the present invention in detail but are not to be construed to limit the scope thereof.

In the following Examples, the following various terms and designations are used wherein: “Rezicure 3000” is phenol novolac resin from SI Corp.; “BPN” is a bisphenol novolac resin from Arakawa Chemical Industries, Ltd.; and “CHTP” stands for cyclohexane tetraphenol; however, this particular compound comprises a mixture of polyphenolic compounds which are described in and prepared as described in WO2009/114383 and WO 2009/114469, incorporated herein by reference. “MTHPA” is a commercial grade of methyl-tetrahydrophthalic anhydride sold as ECA-100 from Dixie Chemical Co. Jeffamine D-230 polyetheramine is a diamine from Huntsman Advanced Materials.

In the following Examples, the following standard analytical equipment and methods are used wherein: “Pot life” is measured by formulation gel time at 70° C. using a GelNorm geltimer from Gel Instrumente AG in accordance to DIN 16 916; and glass transition temperature (“T_{g}”) is measured by differential scanning calorimetry (DSC) using a temperature scan rate of 10° C./minute.

### Examples 1-4

### Compositions of a Stoichiometric Excess of DVBDO and a Polyphenol Having Longer Pot Life

The compositions in Table I were prepared by dissolution of Rezicure 3000 (phenolic equivalent weight=106 g/eq) in divinylbenzene dioxide (DVBDO, epoxide equivalent weight=81 g/eq) at 70° C. using a mechanical stirrer and then adding the curing catalyst 1-benzyl-2-methylimidazole (1B2MZ). After stirring for 1 minute the resulting composition was added to a test tube and placed in a GelNorm geltimer to determine the pot life of the composition wherein the pot life is measured as time to gel (pot life) at 70° C. In Table I, the ratio of epoxide/phenolic equivalents is “r.”

TABLE I

| | | Rezicure | | | Gel Time |
|---|---|---|---|---|---|
| | DVBDO | 3000 | 1B2MZ | | at 70° C. |
| Example | (g) | (g) | (g) | r | (minutes) |
| Comparative | 8.04 | 10.49 | 0.40 | 1.0 | 15 |
| Example A | | | | | |
| Example 1 | 9.00 | 10.72 | 0.37 | 1.1 | 27 |
| Example 2 | 9.00 | 9.82 | 0.38 | 1.2 | 27 |
| Example 3 | 10.01 | 9.36 | 0.38 | 1.4 | 35 |
| Example 4 | 12.04 | 7.85 | 0.33 | 2.0 | 90 |

### Examples 5-12

### Thermosets of a Stoichiometric Excess of DVBDO and a Polyphenol Having Higher Heat Resistance

DVBDO was cured with Rezicure 3000, bisphenol A novolac (BPN, phenolic equivalent weight=128 g/eq), or CHTP (phenolic equivalent weight=127 g/eq) in various stoichiometric ratios (Table II). T_{g} by DSC was obtained after curing using the cure schedules described below. The curing catalyst was 1-benzyl-2-methylimidazole (1B2MZ) at 2 wt % of the composition.

DVBDO and Rezicure 3000 were combined and heated to 75° C. with stirring to dissolve the phenolic resin. Then the catalyst was added and the mixture was stirred for 1 minute. The resulting composition was placed in an Al dish and cured in a recirculating air oven for 1 hour at 200° C.

BPN was melted at ˜130° C. with stirring and allowed to cool to 100° C. upon which DVBDO was added. The mixture was stirred until homogeneous. Then the catalyst was added and the mixture was stirred for 1 minute. The resulting composition was placed in an Al dish and cured in a recirculating air oven for 2 hours at 200° C.

CHTP was melted at ˜160° C. with stirring and allowed to cool to 120° C. upon which DVBDO was added. The mixture was stirred until homogeneous. Then the catalyst was added and the mixture was stirred for 1 minute. The resulting composition was placed in an Al dish and cured in a recirculating air oven for 2 hours at 250° C.

In Comparative Example D, the composition solidified prior to addition of the curing catalyst and was not further tested. In Table II, the ratio of epoxide/phenolic equivalents is “r.”

TABLE II

| | DVBDO | Curing | Mass | | Tg | |
|---|---|---|---|---|---|---|
| Example | (g) | Agent | (g) | r | (° C.) | catalyst |
| Comparative | 2.27 | Rezicure | 2.95 | 1.0 | 134 | none |
| Example B | | 3000 | | | | |
| Comparative | 2.27 | Rezicure | 2.95 | 1.0 | 159 | 1B2MZ |
| Example C | | 3000 | | | | |
| Example 5 | 2.50 | Rezicure | 2.74 | 1.2 | 178 | ″ |
| | | 3000 | | | | |
| Example 6 | 2.74 | Rezicure | 2.53 | 1.4 | 176 | ″ |
| | | 3000 | | | | |
| Example 7 | 3.04 | Rezicure | 1.96 | 2.0 | 206 | ″ |
| | | 3000 | | | | |
| Example 8 | 2.04 | BPN | 2.64 | 1.2 | 211 | ″ |
| Example 9 | 2.07 | ″ | 2.11 | 1.5 | 222 | ″ |
| Example 10 | 2.08 | ″ | 1.58 | 2.0 | 231 | ″ |
| Comparative | 2.00 | CHTP | 3.14 | 1.0 | n/a | — |
| Example D | | | | | | |
| Example 11 | 2.00 | ″ | 2.09 | 1.5 | 243 | 1B2MZ |
| Example 12 | 1.98 | ″ | 1.57 | 2.0 | 245 | ″ |

### Comparative Example E and Examples 13-16

The properties of selected cured products from the formulations of Table II are measured and set forth in Table III. These examples correspond in part to Comparative Example C and Examples 5-7 in Table II. In these Examples plaques weighing about 400 g and 200 mm×300 mm×4 mm in size are prepared by curing DVBDO with Rezicure 3000 in the presence of 1B2MZ catalyst at 80° C. for 60 min., then at 100° C. for 30 min., and finally at 200° C. for 60 minutes in a mold. Coefficients of thermal expansion were determined in the glassy (CTE_{g}) and rubbery (CTEᵣ) regimes using thermomechanical analysis in accordance to ASTM D 696. Thermal decomposition temperature (T_{d}, as extrapolated onset (ext)) and % residue after heating to 600° C. (both under N₂) were determined using thermogravimetric analysis in accordance to ASTM E1131. Tensile modulus (E) and fracture toughness (K_{1C}) were determined in accordance with ASTM D638 and ASTM D-5045, respectively.

TABLE III

| | | T_{g} | CTE_{g} | CTEᵣ | T_{d} (ext) | Residue | E | K_{1C} |
|---|---|---|---|---|---|---|---|---|
| EXAMPLE | r | (° C.) | (μm/m-° C.) | (μm/m-° C.) | (° C.) | (%) | (Mpa) | (MPa-m^{0.5}) |
| Comparative | 1.00 | 154 | 59.70 | 195.3 | 381 | 47.95 | 5018 | 0.72 |
| Example E | | | | | | | | |
| 13 | 1.10 | 166 | 59.34 | 178.2 | 375 | 46.74 | 4893 | 0.70 |
| 14 | 1.20 | 174 | 62.49 | 179.0 | 383 | 45.84 | 4758 | 0.66 |
| 15 | 1.40 | 181 | 65.98 | 174.3 | 381 | 47.85 | 4814 | 0.62 |
| 16 | 2.00 | 206 | 63.84 | 162.0 | 374 | 46.91 | 4616 | 0.67 |

The above results show the examples of the present invention having cured, stoichiometric excess of epoxide groups from DVBDO to have increased T_{g} and maintained mechanical properties compared to the prior art composition having a stoichiometric balance of epoxide/phenolic groups.

### Comparative Example F and Example 17

Plaques of DVBDO-MTHPA thermosets were prepared using the mold as described above. For epoxy-anhydride thermosets the stoichiometric balance is defined using the mole ratios of epoxy resin/anhydride (m). The molecular weights of DVBDO and MTHPA (this commercial grade) are 162 and 164 g/mole, respectively. In Comparative Example F, m=1 (balanced stoichiometry) and 177.0 g DVBDO, 166.6 g MTHPA, and 6.9 g 2-ethyl-4-methylimidazole (2E4MZ) catalyst were used. In Example 17, m=2 and 220.1 g DVBDO, 111.5 g MTHPA, and 6.7 g 2E4MZ catalyst were used. Each sample was cured for 30 min. each at 80, 85, 90, 100, 110, and 150° C. and then for 120 min. at 200° C. Properties were determined as described above and are summarized in Table IV.

TABLE IV

| | | T_{g} | CTE_{g} | CTEᵣ | T_{d} (ext) | Residue | E | K_{1C} |
|---|---|---|---|---|---|---|---|---|
| EXAMPLE | m | (° C.) | (μm/m-° C.) | (μm/m-° C.) | (° C.) | (%) | (Mpa) | (MPa-m^{0.5}) |
| Comparative | 1.0 | 180 | 75.88 | 190.1 | 329 | 18.4 | 3631 | 0.52 |
| Example F | | | | | | | | |
| 17 | 2.0 | 197 | 68.58 | 180.3 | 337 | 29.6 | 3450 | 0.54 |

The above results show the examples of the present invention having cured, stoichiometric excess of epoxide groups from DVBDO to have increased T_{g} and maintained mechanical properties compared to the prior art composition having a stoichiometric balance of epoxide/anhydride groups.

### Comparative Example G and Example 18

Specimens of DVBDO-Jeffamine D-230 thermosets were prepared by curing formulations in an aluminum dish. The equivalent weights of DVBDO and Jeffamine D-230 polyetheramine are 81 g/mole and 115 g/mole, respectively. In Comparative Example G, r=1 (balanced stoichiometry) and 2.0 g DVBDO and 1.5 g D-230 was cured for 1 hour each at 100° C., 120° C., 140° C., and 150° C. In Example 18, r=2 and 3.0 g DVBDO, 1.0 g MTHPA, and 0.08 g 1B2MZ were cured for 30 minutes each at 80° C., 85° C., 95° C., 105° C., 120° C., 140° C., 160° C., 180° C. and 1 hour at 200° C. Properties of the cured thermosets were determined as described above and are summarized in Table V.

TABLE V

| | | T_{g} |
|---|---|---|
| EXAMPLE | r | (° C.) |
| Comparative Example G | 1.0 | 115 |
| 18 | 2.0 | 189 |

The above results show the examples of the present invention having cured, stoichiometric excess of epoxide groups from DVBDO to have increased T_{g} compared to the prior art composition having a stoichiometric balance of epoxide/amine groups.

What is claimed is:

1. A curable divinylarene dioxide-containing epoxy resin composition comprising (a) a stoichiometric excess of at least one divinylarene dioxide, (b) a co-reactive curing agent, and (c) a catalyst.

2. The composition of claim 1, wherein the composition has a pot life of from about 10% to about 10,000% greater than its stoichiometric analog.

3. The composition of claim 1, wherein the divinylarene dioxide is selected from the group divinylbenzene dioxide, divinylnaphthalene dioxide, divinylbiphenyl dioxide, divinyldiphenylether dioxide, and mixtures thereof.

4. The composition of claim 1, wherein the divinylarene dioxide is divinylbenzene dioxide.

5. The composition of claim 1, wherein the concentration of said divinylarene dioxide ranges from a stoichiometric ratio of epoxide to co-reactive curing agent groups of about 1.05 to about 10.

6. The composition of claim 1, wherein the co-reactive curing agent comprises an amine, a carboxylic acid anhydride, a polyphenol, a thiol, or mixtures thereof.

7. The composition of claim 1, wherein the catalyst comprises a tertiary amine, an imidazole, an ammonium salt, a phosphonium salt, or mixtures thereof.

8. The composition of claim 1, wherein the concentration of the catalyst ranges from about 0.01 weight percent to about 20 weight percent.

9. A process for preparing a curable divinylarene dioxide-containing epoxy resin composition comprising admixing (a) a stoichiometric excess of at least one divinylarene dioxide, (b) a co-reactive curing agent, and (c) a catalyst.

10. A process for preparing a cured thermoset comprising
(a) preparing a curable divinylarene dioxide-containing epoxy resin composition comprising admixing (a) a stoichiometric excess of at least one divinylarene dioxide, (b) a co-reactive curing agent, and (c) a catalyst; and
(b) heating the composition of step (a) at a temperature of from about 40° C. to about 300° C.

11. The process of claim 10, including forming the composition of step (a) into an article prior to the heating step.

12. A thermoset cured product prepared by curing the composition of claim 1.

13. The product of claim 12, wherein the thermoset cured product has a glass transition temperature increased over that of its stoichiometric analog from about 5% to about 100%.

14. The product of claim 12, wherein the thermoset cured product comprises a coating, an adhesive, a composite, an encapsulant or a laminate.
